(19) United States
(12) Patent Application Publication
(10) Pub. No.: US 2002/0076679 A1
(43) Pub. Date: Jun. 20, 2002

(54) Web enabled medical device training

(76) Inventor: Craig S. Aman, Seattle, WA (US)

Correspondence Address: PHILIPS ELECTRONICS NORTH AMERICAN, 580 WHITE PLAINS ROAD, TARRYTOWN, NY, 10591, US

(21) Appl. No.: 09/739,357

(22) Filed: Dec. 19, 2000

(51) Int. Cl. G09B 23/28

(52) U.S. Cl. 434/262

(57) ABSTRACT

A trainee responder interacts with a simulated medical device to operate controls and device instruments to perform first aid techniques during an interactive medical device training. Moreover, feedback is provided for each simulation interaction. The feedback can be used to assess the trainee's competence in operating medical device controls and performing first aid techniques with the medical device. The feedback indicates to a trainee user whether a simulation interaction is appropriate and performed correctly. The simulated medical device controls and instruments may be displayed as graphical user interfaces on a trainee responder computer. The trainee responder may navigate between the graphical user interfaces. Each of the graphical user interfaces may teach a particular concept related to the subject medical device.

### BACKGROUND OF THE INVENTION

1. Field of the Invention

The present invention relates to a method, system, method of doing business, and computer program product for providing device training. More particularly, the present invention relates to a method, system, method of doing business, and computer program product for providing medical device training.

2. Description of the Prior Art

The present invention relates to a method, system, method of doing business, and computer program product for providing medical device training. There are a number of emergency medical situations where the survival of emergency medical victims is dependent on the administration of first aid with an emergency medical device. Sudden Cardiac Arrest (hereinafter “SCA”) is one such emergency medical situation. SCA is usually caused by an electrical malfunction of the heart. The survival of emergency medical victims depends on the proficiency of the operator, such as an emergency medical responder, in the use of the emergency medical device, such as an Automatic External Defibrillator (hereinafter “AED”). However, broad ranges of responders operate emergency medical devices. Each of the responders potentially receives different medical device training. Differing medical device training occurs primarily because of the lack of uniformity in training content and training format received by each responder.

Accordingly, there is a need for medical device training that is uniform for a variety of emergency medical responders. Moreover, the medical device training must be accessible from a variety of locations. There is a further need for the medical device training to include operating controls and performing emergency first aid techniques associated with medical devices. Moreover, the medical device training must simulate medical device controls and first aid techniques. The simulation must be interactive. The simulation must also provide feedback to interaction.

### SUMMARY OF THE INVENTION

A first embodiment of the present invention is a method for providing instructional information on the use of a medical device to a user computer. The method receives a request for instructional information on the use of the medical device over a network, the request originating from the user computer. In response to the request, the method provides a first graphical user interface having a list of instructional topics associated with the medical device to the user computer. The method provides a second graphical user interface having a list of instructional subtopics associated with an item on the list of instructional topics to the user computer in response to receiving a request for the item on the list of instructional topics from the user computer. The method then provides a plurality of instructional graphical user interfaces having instructional information pertaining to an item on the list of instructional sub-topics to the user computer in response to receiving a request for the item on the list of the instructional sub-topic from the user computer.

A second embodiment of the present invention is a system for providing instructional information on the use of a medical device. The system includes a network, a user computer coupled to the network for requesting instructional information on the use of the medical device, a server couple to the network. The server provides a first graphical user interface having a list of instructional topics associated with the medical device to the user computer in response to the request for instruction. The server then provides a second graphical user interface having a list of instructional sub-topics associated with an item on the list of instructional topics to the user computer in response to receiving a request for the item on the list of instructional topics from the user computer. Finally, the server provides a plurality of instructional graphical user interfaces having instructional information pertaining to an item on the list of instructional sub-topics to the user computer in response to receiving a request for the item on the list of the instructional sub-topic from the user computer.

A third embodiment of the present invention is a computer program article of manufacture. The article of manufacture includes a computer-readable medium for providing instructional information on the use of a medical device. The computer-readable medium is provided with executable instructions for receiving a request for instructional information on the use of the medical device, providing a first graphical user interface having a list of instructional topics associated with the medical device to the user computer in response to the request, providing a second graphical user interface having a list of instructional sub-topics associated with an item on the list of instructional topics to the user computer in response to receiving a request for the item on the list of instructional topics from the user computer, and providing a plurality of instructional graphical user interfaces having instructional information pertaining to an item on the list of instructional sub-topics to the user computer in response to receiving a request for the item on the list of the instructional sub-topic from the user computer.

A fourth embodiment of the present invention is a business method for providing instructional information on the use of a medical device to a customer computer. The business method receives a request for instructional information on the use of the medical device over a network, the request originating from the customer computer. In response to the request, the business method provides a first graphical user interface having a list of instructional topics associated with the medical device to the customer computer. The business method then provides a second graphical user interface having a list of instructional sub-topics associated with an item on the list of instructional topics to the customer computer in response to receiving a request for the item on the list of instructional topics from the customer computer. Finally, the business method provides a plurality of instructional graphical user interfaces having instructional information pertaining to an item on the list of instructional sub-topics to the customer computer in response to receiving a request for the item on the list of the instructional sub-topic from the customer computer.

### BRIEF DESCRIPTION OF THE DRAWINGS

The details of the present invention, both as to its structure and operation can best be understood by referring to the following description with reference to the accompanying drawings in which:

FIG. 1 is a diagram of a network in accordance with the preferred embodiment of the present invention;

FIG. 2 is a block diagram of a server in accordance with an embodiment the present invention;

FIG. 3 is a block diagram of a trainee computer in accordance with an embodiment of the present invention;

FIG. 4 is a flow diagram depicting a method for providing medical device training in accordance with an embodiment the present invention;

FIG. 5 is an exemplary training topic screen in accordance with an embodiment of the present invention;

FIG. 6 is an exemplary training sub-topic screen in accordance with an embodiment of the present invention; and

FIGS. 7-11 are exemplary medical device training information screens in accordance with embodiments of the present invention.

### DETAILED DESCRIPTION OF THE INVENTION

The present invention is now described more fully hereinafter with reference to the accompanying drawings that show preferred embodiments of the present invention. The present invention, however, may be embodied in many different forms and should not be construed as limited to the embodiments set forth herein. Appropriately, the preferred embodiments are provided so that this disclosure will be thorough and complete, and will fully convey the scope of the present invention.

As will be appreciated by one having skill in the art, the present invention relates to a method, system, computer program product and method of doing business. The computer program product includes a computer-readable storage medium having computer-readable program instruction stored in the medium. Any suitable computer-readable medium may be utilized including hard disks, CD-ROMs, floppy disks, optical storage devices, magnetic storage devices, etc.

The present invention is a method, method of doing business, computer program product and system for providing medical device training. As used herein the term medical device training is meant to convey training in operating controls and performing first aid techniques associated with a medical device. The training includes providing simulated medical device controls, for trainee interaction, and allowing the simulation of first aid techniques. The training also includes providing feedback to interaction with simulated medical device controls and simulation of first aid techniques.

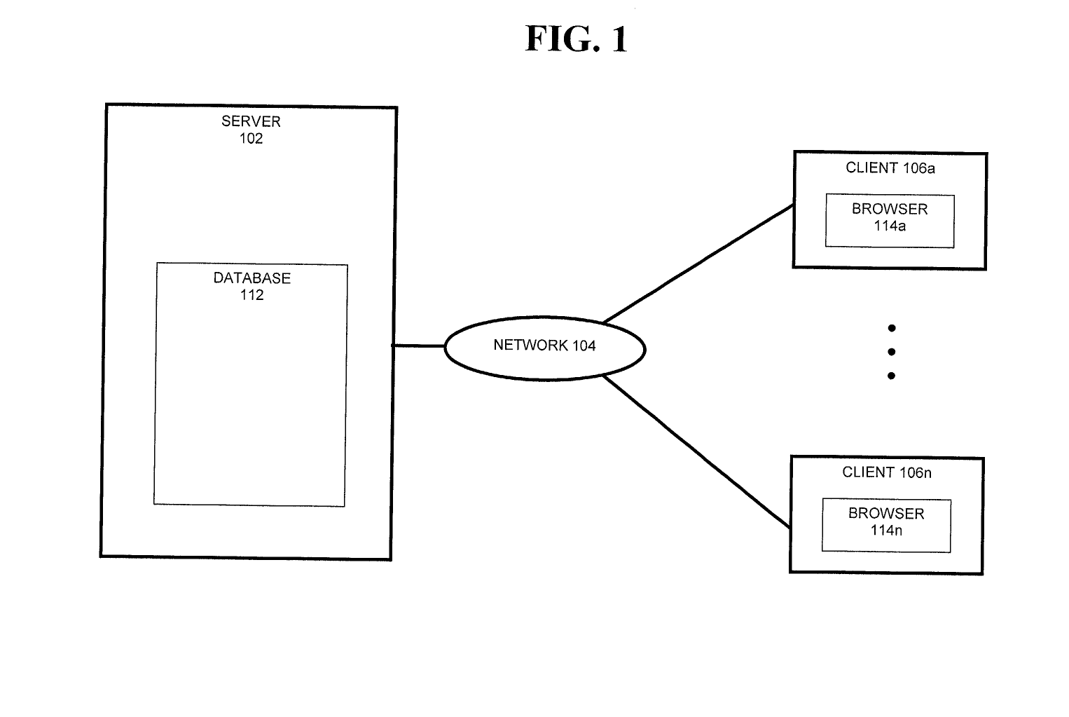

FIG. 1 is a diagram of a system in accordance with the preferred embodiment of the present invention. In the preferred embodiment of FIG. 1, system 100 includes a server computer 102 connected over a network 104 to a plurality of trainee computers 106. Various types of responder trainees may use trainee computers 106. Examples of responder trainees include Emergency Medical Service professionals, merchant owners, or any individual who may need to operate the device. Computers 106 may communicate with server 102 over network 104. Network 104 allows, but is not limited to, communication between computers 106 server 102. In the preferred embodiment, network 104 is a Wide Area Network (WAN), such as the Internet. In an alternative embodiment, network 104 is a Local Area Network (LAN) such as an Intranet. Responders access network 104 using computers 106a-106n having browser programs 114a-114n respectively. Server 102 may stores medical device training information.

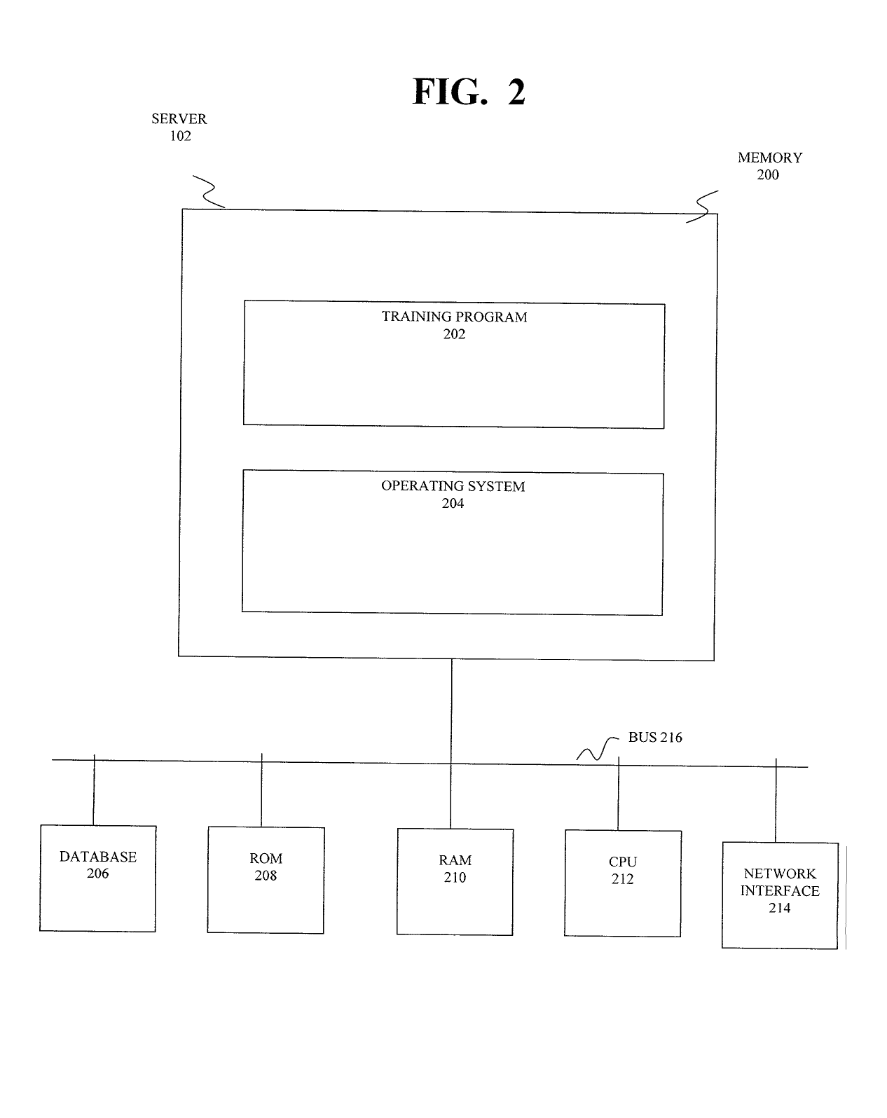

FIG. 2 is a block diagram of server 102 in accordance with an embodiment the present invention. In the FIG. 2 embodiment, server 102 implements, but is not limited to, the methods of the present invention. In the FIG. 2 embodiment, the server 102 includes components, such as, a central processing unit (CPU) 212, connected by a bus 216 to memory 200, a database 206, read only memory (ROM) 208, random access memory 210, and network interface 214.

In the FIG. 2 embodiment, CPU 212 is a microprocessor, such as an INTEL PENTIUM® processor, but may be any processor that executes program instructions in order to carry out the functions of the present invention. As shown, CPU 212 and the various other components of the server 102 communicate through a system bus 216 or similar architecture. CPU 212 connects to database 206 using systems bus 216. In the FIG. 2 embodiment, network interface 224 enables the data contained in data database 206 to transmit over network 104 under the direction of CPU 212.

In the FIG. 2 embodiment, database 206 is located in a data storage device, such as, magnetic, optical or other digital storage media. Database 206 stores data, such as, information used to implement the present invention. In the preferred embodiment, database 206 stores medical device training information. The medical device training information has a format that can be understood by browser 308, such as HTML or XML. The medical device training information may be stored as segments that may be accessed. In the FIG. 2 embodiment, segments accessible at once correspond to a structure, such as, a web page. Segments may have an associated network address that may identify the location of the segments in database 206.

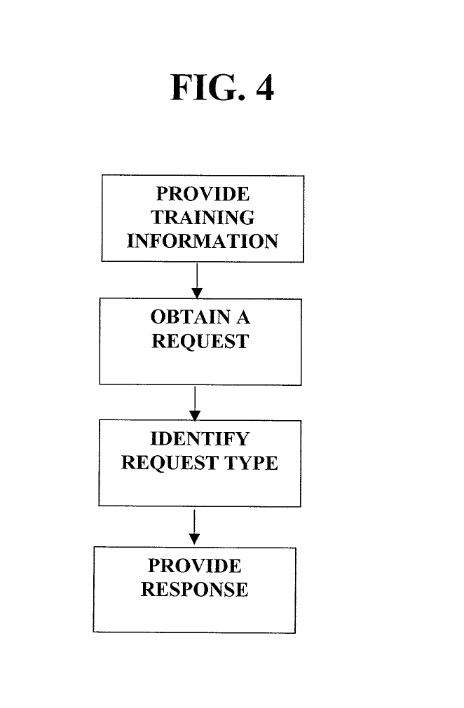

In the FIG. 2 embodiment, memory 200 stores data, such as, device training program routine 202, and operating system 204. Device training program routine 202 includes code, such as, computer program instructions that may be executed by CPU 212. In the preferred embodiment, Device training program routine 202 is loaded into systems memory 200 and performs the functions, as described in detail hereinafter, implemented by the present invention as illustrated in FIG. 4. In an alternative embodiment, device training program routine 202 may be stored on computer readable media and used therefrom by server 102 to perform the specified functions or steps in accordance with the present invention. Operating system 204 may provide overall system functionality. Operating system 204, after being initially loaded into the computers 106, manages all the other programs in a computer, such as device and technique training program routine 202.

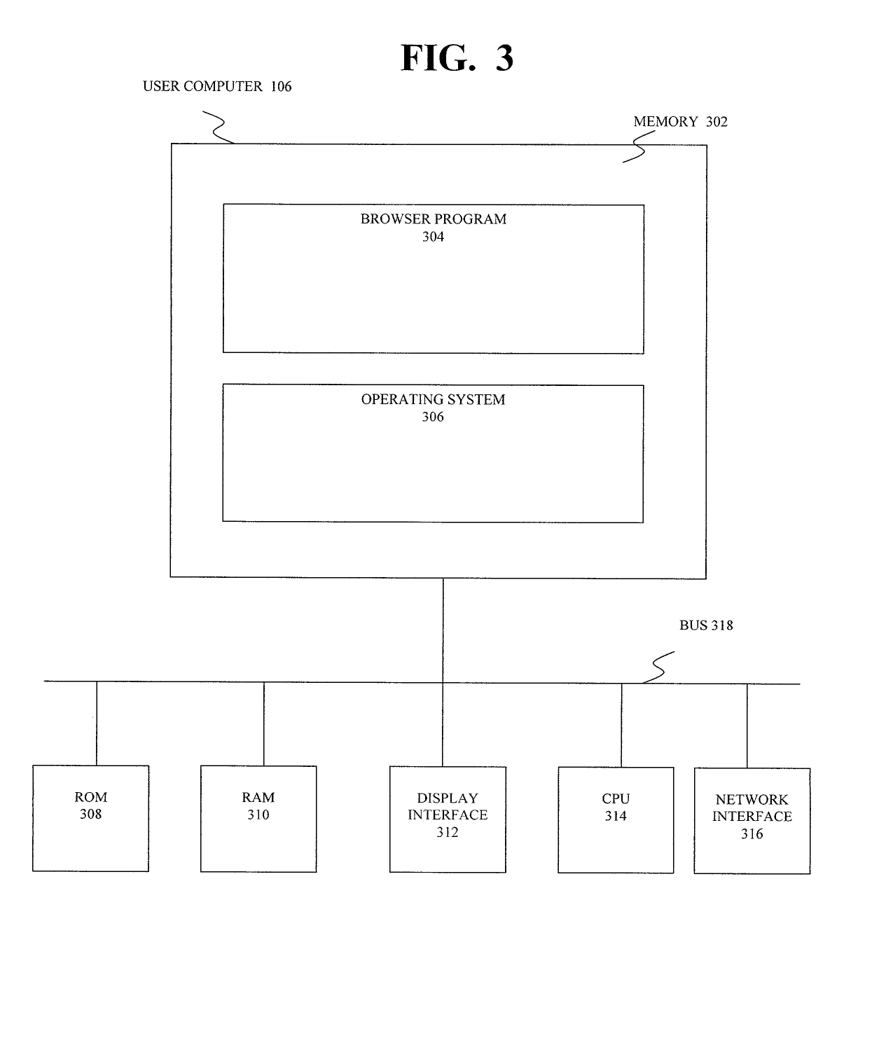

FIG. 3 is a block diagram of a trainee computer in accordance with an embodiment of the present invention. In the FIG. 3 embodiment, trainee computers 106 may include components, such as, a central processing unit (CPU) 314, connected by a bus 318 to the memory 302, a read only memory (ROM) 308, random access memory (RAM) and network interface card 316 which is connected to network 104 for communication with server 102. Trainee computers 106 may also include, interfaces, such as, display interface 312 and input interface 318.

In the FIG. 3 embodiment, display interface 312 enables the display of information, such as, medical device operation and first aid technique information. Input interface enables the manipulation of information, such as selecting information displayed on display interface 312.

In the FIG. 3 embodiment, Systems Memory 302 stores data, such as Browser Program 304, and operating system 306. Browser Program 304 includes code, such as, computer program instructions executed by CPU 320. In the preferred embodiment of the present invention, Browser Program 304 is loaded into systems memory 302. Browser Program 304 enables the information content available at server devices 102 to be provided to computer device 106 in a manner that can be understood by a user. The browser 304 serves as a front end to the World Wide Web on the Internet and is designed to display one web page at a time.

FIG. 4 is a flow diagram depicting a method for providing medical device training in accordance with an embodiment the present invention. In the FIG. 4 embodiment, medical device training program 202 may cause a series of operational steps to be performed, producing a computer implemented process, so that a server, such as server 102 implements the methods specified in FIG. 4. Although, the present invention is described in terms of providing medical device training for an Automatic External Defibrillator (AED), the present invention can be used for any number of devices.

The present invention has features that are beneficial to other types of device and technique training, medical and non-medical. These features may allow a user of the present invention to easily and effectively understand the proper operation of devices. The proper operation of devices includes actions, such as manipulating the controls of devices as well as performing first aid techniques with the devices. Understanding the proper operation of devices is facilitated by responder trainee interaction with objects, such as computer generated simulated device controls and device instruments used to perform first aid. Moreover, the objects may provide feedback when interacted with by trainee responder.

In the preferred embodiment of the present invention, a trainee responder interacts with a simulated medical device to operate controls and device instruments to perform first aid techniques. Moreover, feedback is provided for each simulation interaction. The feedback can be used to assess the trainee's competence in operating medical device controls and performing first aid techniques with the medical device. The feedback indicates to a trainee user whether a simulation interaction is appropriate and performed correctly. In the preferred embodiment of the present invention, the present invention resides at a World Wide Web Internet site that is easily accessible to all potential users. In an alternative embodiment, the present invention resides on an Intranet.

In Step 400 of the FIG. 4 embodiment, server 102 may provide available medical device training information. Available medical device training information may be provided as a medical device training information screen. Medical device training information may be transmitted from server 102 to client computers 106a-106n over network 104. A medical device training information screen may be displayed on client computers 106a-106n using browsers 114a-114n. A medical device training information screen may be provided using a training sub-topic screen. The training sub-topic screen may include any number of objects that provide access to medical device training information screens related to the sub-topic.

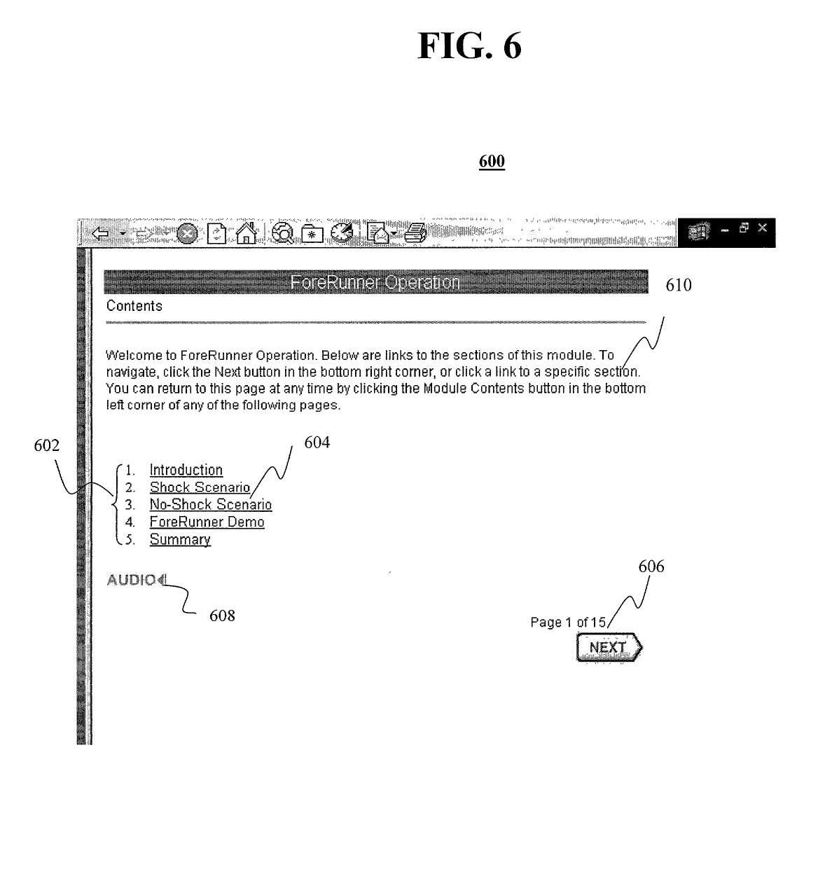

Turning briefly to the embodiment FIG. 6. FIG. 6 is an exemplary training subtopic screen display of a useful for providing access to medical device training information screens. In the FIG. 6 embodiment, screen display 600 includes objects, such as, a list 602 of training sub-topic objects, navigation object 606, audio object 608 and welcome text 610. The list 602 of training sub-topic objects relates to medical device training information, such as, operating device controls and performing first aid techniques. Each sub-topic object on the list of training subtopics may be a link 604. A link 604 may provide access to a medical device training information screen that conveys concepts related to the sub-topic referenced by the link 604. One having ordinary skill in the art should recognize that list 602 of subtopics is illustrative and that any number of different sub-topics can be used. Access may be provided through selection of a link 604 using input interface 318.

Audio object 608 enables a user to initiate an audio that relates to and supplements text, such as, welcome text 610. Navigation object 606 allows a user to index through medical device training screens, such as to a medical device training information screen which follows or proceeds a currently accessed information screen. Welcome text 610 may provide instruction in the use of sub-topic training screen 600.

Returning to Step 400 of the FIG. 4 embodiment, a training sub-topic screen may be provided using a training topic screen. The training topic screen may include any number of objects that provide access to a training sub-topic screen.

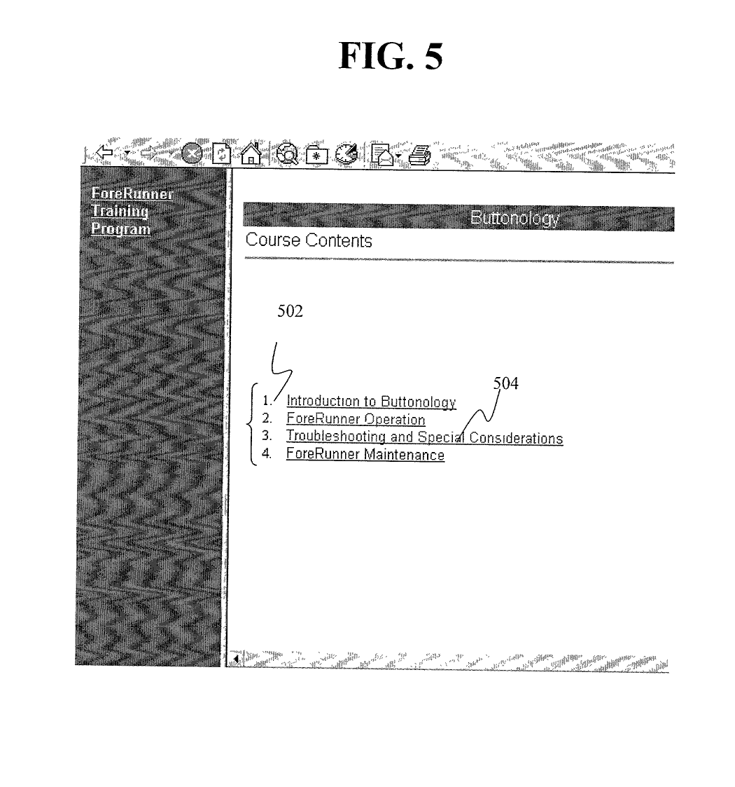

Turning briefly to the embodiment of FIG. 5. FIG. 5 is an exemplary training topic screen in accordance with an embodiment of the present invention. In the FIG. 5 embodiment, the topic screen includes objects, such as, a list 502 of training topic objects. The list 502 of training topic objects relates to medical device training information, such as operating device controls and performing first aid techniques. Each topic object on the list of training topics may be a link 504. A link 504 may provide access to a sub-topic screen related to the concept of the topic referenced by the link 504. Access may be provided through selection of a link 504 using input interface 318.

Returning again to FIG. 4 embodiment. In Step 402 of the FIG. 4 embodiment, server 102 may obtain a request. The request may be generated through responder trainee interaction with an object on a medical device training screen. The types of request obtained may include a feedback request, a navigation request, an audio request and a video request. Interaction with an object may include user selection and user manipulation, such as placement and positioning, of objects on a medical device training screen with input interface 318. The request may be transmitted from client computer 106a-106n to server 102 over network 104.

In Step 404, server 102 may identify the request type. The request type is based on the object on the medical device training screen that generated the request as a result of interaction. In the FIG. 4 embodiment, a feedback request is generated by interactive simulation objects, such as simulated medical device control and simulated medical device first aid instruments. A navigation request is generated by navigation objects, such as a back navigation object, a next navigation object and a modules navigation object. An audio request is generated by objects such as an audio object. A video request is generated by objects such as a video object.

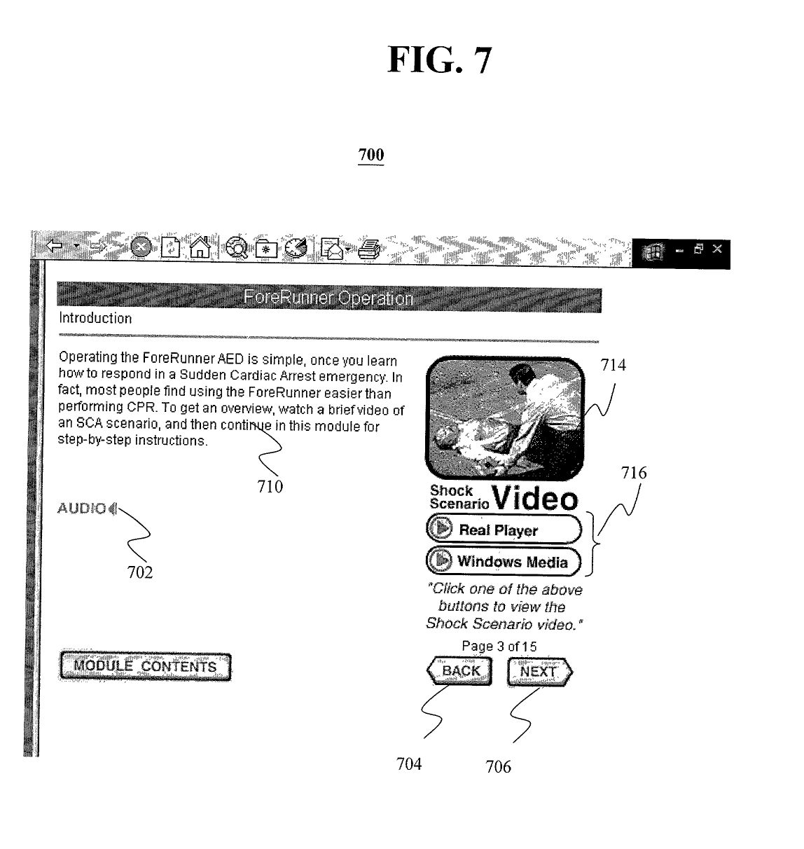

Turning briefly to the embodiments of FIGS. 7-11. FIGS. 7-11 are exemplary medical device training information screens in accordance with embodiments of the present invention. In each of the FIGS. 7-11 embodiments, the medical device training screens include instructional text, an audio object, a video object, navigation objects, and interactive simulation objects.

In the embodiments of FIGS. 7-11, instructional text, audio object and navigation objects are illustrated. In the FIG. 7 embodiment, Instructional text 710 may convey concepts related to medical device training. Audio object 702 enables a user to initiate an audio that relates to text, such as, instructional text. A next navigation object 704 may provide a medical device training information screen that immediately follows a currently provided medical device training information screen. A next navigation 704 may be performed upon a user-initiated action, such as, selecting a next navigation object 704 on a medical device navigation screen. A back navigation 706 object may provide a medical device training information screen that immediately precedes a currently provided medical device training information screen. A back navigation 706 may be performed upon a user initiated action, such as, selecting a back navigation object 706 on a medical device navigation screen.

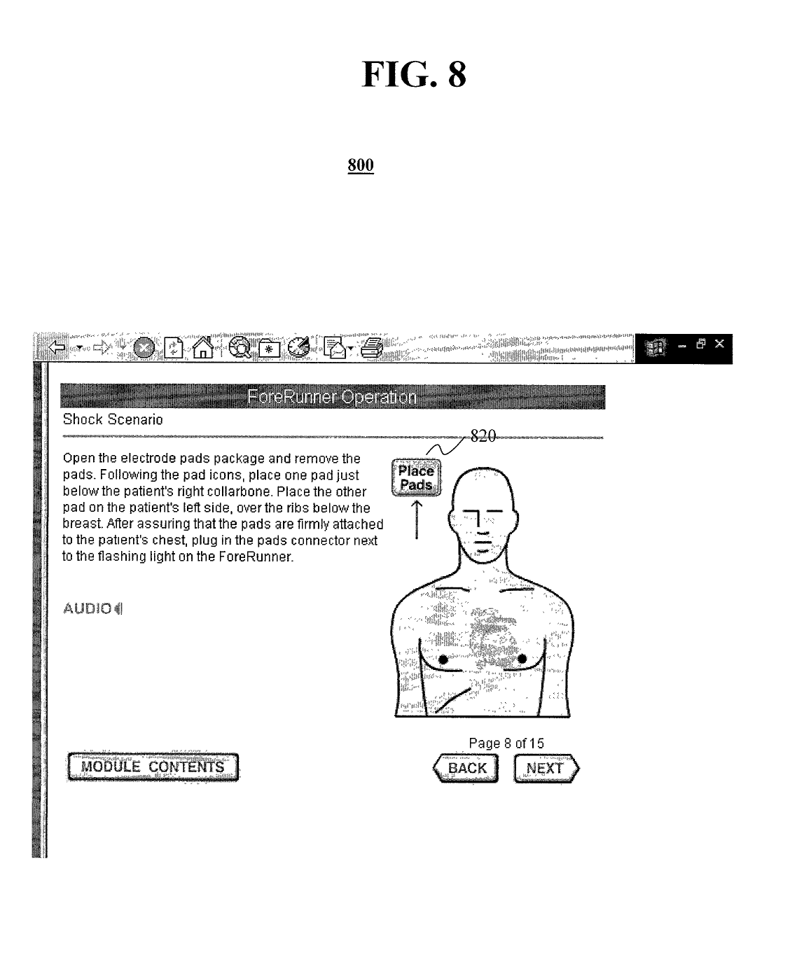

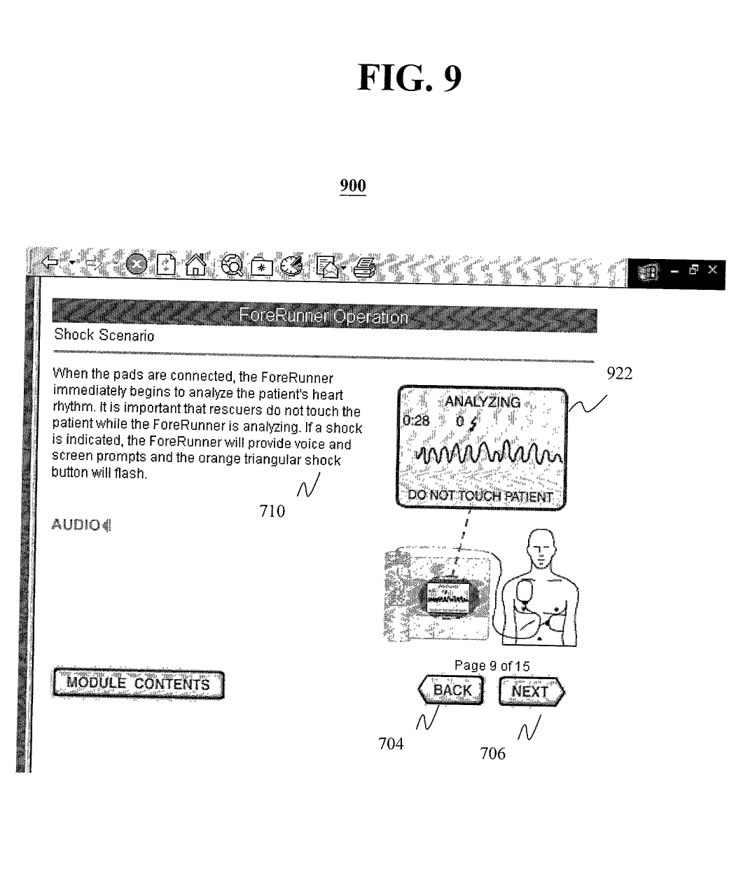

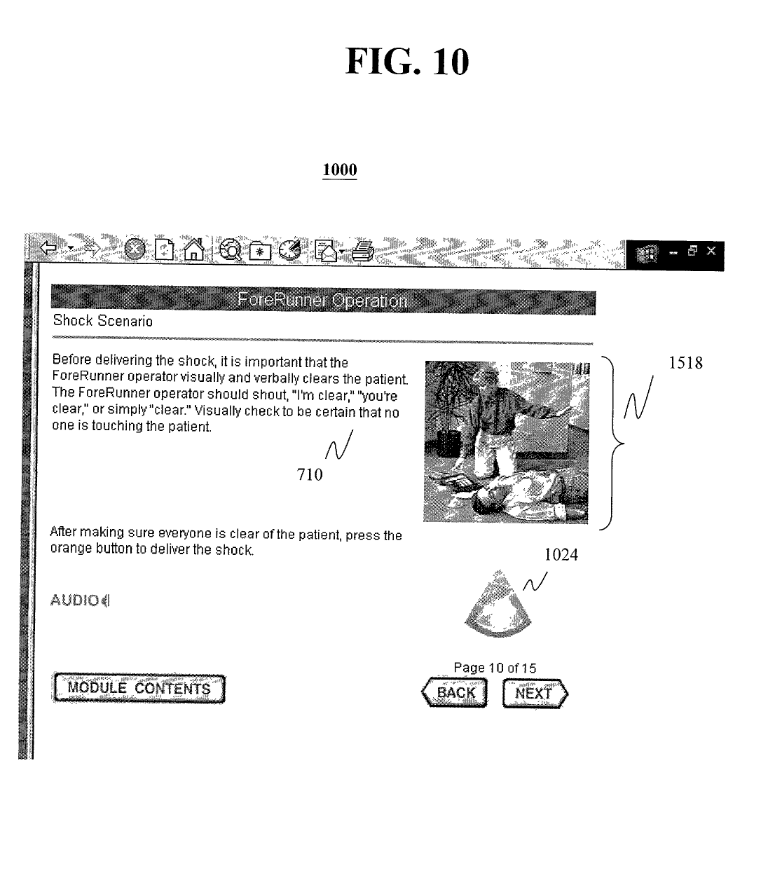

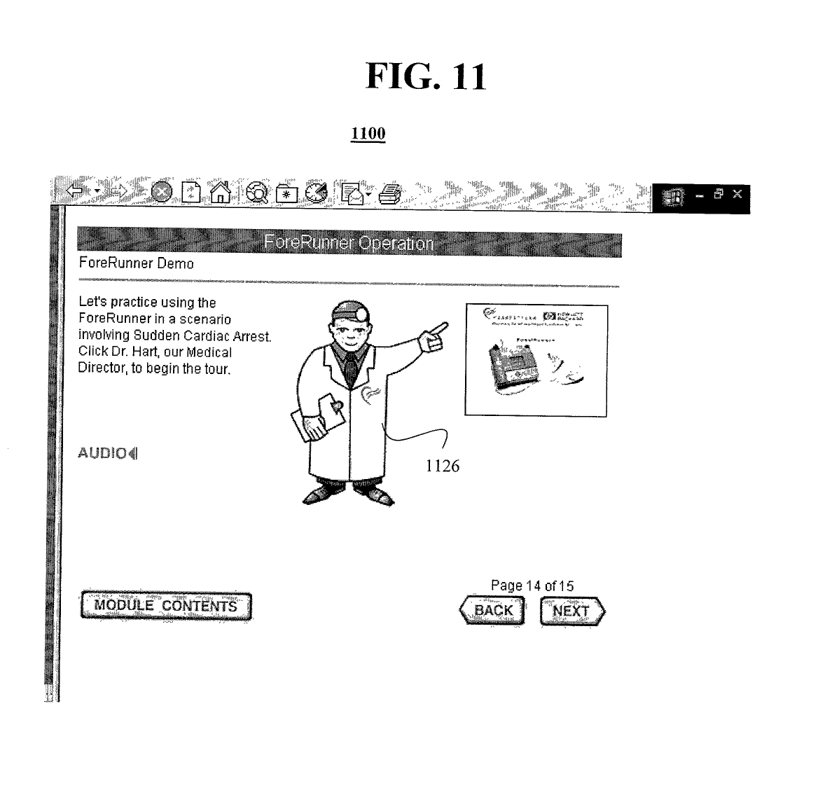

In the FIG. 7 embodiment, a video object 716 is illustrated. A video object may launch a video. The video may be displayed in a video area of the medical device training information screen. The video may be directed to a topic associated with the medical device training screen and the concept disclosed by the instructional text. In the FIG. 8 embodiment, an interactive simulation object, such as an interactive first aid demonstration technique object 820, is illustrated. An interactive first aid demonstration technique object 820 may demonstrate a first aid technique that may be performed with by the device for which a responder is receiving training. The first aid technique demonstration may solicit user interaction, such as manipulation and placement of simulated medical device first aid instrument objects. Interaction with simulated medical device first aid instrument objects generate feedback that indicates whether the interaction was proper or performed correctly. In the FIG. 9 embodiment, an animation image object 922 is illustrated. The animation object 922 simulates a monitor or the like associated with the medical device for which training is being provided. In the FIG. 10 embodiment, an interactive simulation object, such as a simulated medical device control object 1024, is illustrated. Interaction with simulated medical device control objects generate feedback that indicates whether the interaction was proper or performed correctly. In the FIG. 11 embodiment, a testing object 1126 is illustrated. The testing object generates a test corresponding to the instructional information provided by the medical device training.

Returning to Step 406 of the FIG. 4 embodiment, server 102 may provide a response. The response provided may include initiating an audio that relates to text, providing a medical device training information screen that immediately follows a currently provided medical device training information screen, providing a medical device training information screen that immediately precedes a currently provided medical device training information screen, launching a video, demonstrating a first aid technique that may be performed by the device for which a responder is receiving training, and generating feedback that indicates whether the interaction was proper or performed correctly. The response provided is based on the request type identified in Step 404. The response is transmitted from server 102 to computer 106a-106n over network 104. The response may be displayed on a monitor of computer 106a-106n for viewing by a responder trainee.

The present invention is described hereinabove with reference to flowchart illustrations of methods, apparatus (systems), methods of doing business and computer program products according to the invention. It will be understood that each block of the flowchart illustrations, and combinations of blocks in the flowchart illustrations, can be implemented by computer program instructions. These computer program instructions may be loaded onto a general-purpose computer, special purpose computer, or other programmable data processing apparatus to produce a machine. These computer program instructions, which execute on the computer or other programmable data processing apparatus, create means for implementing the functions specified in the flowchart block or blocks. These computer program instructions may be stored in a computer-readable memory to direct a computer or other programmable data processing apparatus to function in a particular manner, producing an article of manufacture including instruction means which implement the function specified in the flowchart block or blocks. The computer program instructions may also be loaded onto a computer or other programmable data processing apparatus to cause a series of operational steps to be performed, producing a computer implemented process, such that the computer or other programmable apparatus provide steps for implementing the functions specified in the flowchart block or blocks.

Accordingly, blocks of the flowchart illustrations support combinations of means for performing the specified functions, combinations of steps for performing the specified functions and program instruction means for performing the specified functions. It will also be understood that each block of the flowchart illustrations, and combinations of blocks in the flowchart illustrations, can be implemented by special purpose hardware-based computer systems which perform the specified functions or steps, or combinations of special purpose hardware and computer instructions.

Although specific embodiments of the present invention have been described, it will be understood by those skilled in the art that there are other embodiments that are equivalent to the described embodiments. Accordingly it is to be understood that the invention is not to be limited by the specific illustrated embodiments, but only be the scope of the appended claims.

1) A method for providing instructional information on the use of a medical device to a user computer, the method comprising:
a) receiving a request for instructional information on the use of the medical device over a network, the request originating from the user computer;
b) providing a first graphical user interface having a list of instructional topics associated with the medical device to the user computer in response to the request;
c) providing a second graphical user interface having a list of instructional subtopics associated with an item on the list of instructional topics to the user computer in response to receiving a request for the item on the list of instructional topics from the user computer; and
d) providing a plurality of instructional graphical user interfaces having instructional information pertaining to an item on the list of instructional subtopics to the user computer in response to receiving a request for the item on the list of the instructional sub-topic from the user computer.

2) The method according to claim 1, wherein the medical device is an Automatic External Defibrillator (AED).

3) The method according to claim 1, wherein the list of instructional topics include at least a utility of the medical device item, an operation of the medical device item, a device troubleshooting item and a device maintenance item.

4) The method according to claim 1, further comprising:
a) providing an audio in at least one of the graphical user interfaces.

5) The method according to claim 1, further comprising:
a) providing linear and non-linear navigation from at least one of the graphical user interfaces s to another of the graphical user interfaces.

6) The method according to claim 1, wherein the instructional information in each of the plurality of instructional graphical user interface includes a text description of one or more operational steps pertaining to the selected item on the list of instructional sub-topics.

7) The method according to claim 6, further comprising:
a) providing in one or more of the plurality of instructional graphical user interfaces one or more still images illustrating the text description of the one or more operational steps.

8) The method according to claim 6, further comprising:
a) providing in one or more of the plurality of instructional graphical user interfaces an interactive animation illustrating the text description of the one or more operational steps.

9) The method according to claim 6, further comprising:
a) providing in one or more of the plurality of instructional graphical user interfaces a video illustrating the text description.

10) The method according to claim 6, wherein each of the plurality of instructional graphical user interfaces is provided based on the order in which the one or more operational steps in the text description would be performed during the proper operation of the device.

11) The method according to claim 10, wherein the medical device is an Automatic External Defibrillator (AED).

12) The method according to claim 10, further comprising:
a) providing in one or more of the plurality of instructional graphical user interfaces an interactive animation illustrating the text description of the one or more operational steps.

13) The method according to claim 12, wherein user interaction is required for the animation illustrating the text description of the one or more operational steps.

14) A system for providing instructional information on the use of a medical device, the system comprising:
a) a network;
b) a user computer coupled to the network for requesting instructional information on the use of the medical device; and
c) a server couple to the network;
wherein the server provides a first graphical user interface having a list of instructional topics associated with the medical device to the user computer in response to the request for instruction, provides a second graphical user interface having a list of instructional sub-topics associated with an item on the list of instructional topics to the user computer in response to receiving a request for the item on the list of instructional topics from the user computer, and provides a plurality of instructional graphical user interfaces having instructional information pertaining to an item on the list of instructional sub-topics to the user computer in response to receiving a request for the item on the list of the instructional sub-topic from the user computer.

15) The system according to claim 14, wherein the medical device is an Automatic External Defibrillator (AED).

16) The system according to claim 14, wherein the network is the Internet or an Intranet.

17) The system according to claim 14, wherein the list of instructional topics include at least a utility of the medical device item, an operation of the medical device item, a device troubleshooting item and device maintenance item.

18) The system according to claim 14, further comprising:
a) an audio object provided in at least one of the graphical user interfaces permitting the user to listen to an audio.

19) The system according to claim 14, further comprising:
a) a linear navigation object and a non-linear navigation object provided in at least one of the graphical user interfaces permitting the user to navigate from the at least one of the graphical user interface displays to another of the graphical user interfaces.

20) The system according to claim 14, wherein the instructional information includes a text description of one or more operational steps pertaining to the selected item on the list of instructional sub-topics.

21) The system according to claim 20, further comprising:
a) at least one still image object provided in each of the plurality of instructional graphical user interfaces for illustrating the text description of the one or more operational steps.

22) The system according to claim 20, further comprising:
a) an interactive animation object provided in the at least one instructional graphical user interfaces for illustrating the text description of the one or more operational steps.

23) The system according to claim 20, further comprising:
a) a video object provided in at least one of the plurality of instructional graphical user interfaces for illustrating the text description of the at least one instructional graphical display.

24) The system according to claim 20, wherein each of the plurality of instructional graphical user interfaces is provided based on the order in which the one or more operational steps in the text description would be performed during the proper operation of the device.

25) The system according to claim 24, wherein the medical device is an Automatic External Defibrillator (AED).

26) A computer program article of manufacture, comprising:
a) a computer-readable medium for providing instructional information on the use of a medical device;
b) executable instructions in the computer-readable medium for receiving a request for instructional information on the use of the medical device over a network, the request originating from a user computer;
c) executable instructions in the computer-readable medium for providing a first graphical user interface having a list of instructional topics associated with the medical device to the user computer in response to the request;
d) executable instructions in the computer-readable medium for providing a second graphical user interface having a list of instructional sub-topics associated with an item on the list of instructional topics to the user computer in response to receiving a request for the item on the list of instructional topics from the user computer; and
e) executable instructions in the computer-readable medium for providing a plurality of instructional graphical user interfaces having instructional information pertaining to an item on the list of instructional sub-topics to the user computer in response to receiving a request for the item on the list of the instructional sub-topic from the user computer.

27) A business method for providing instructional information on the use of a medical device to a customer computer, the method comprising:
a) receiving a request for instructional information on the use of the medical device over a network, the request originating from the customer computer;
b) providing a first graphical user interface having a list of instructional topics associated with the medical device to the customer computer in response to the request;
c) providing a second graphical user interface having a list of instructional subtopics associated with an item on the list of instructional topics to the customer computer in response to receiving a request for the item on the list of instructional topics from the customer computer; and
d) providing a plurality of instructional graphical user interfaces having instructional information pertaining to an item on the list of instructional subtopics to the customer computer in response to receiving a request for the item on the list of the instructional sub-topic from the customer computer.

28) The business method according to claim 27, wherein the medical device is an Automatic External Defibrillator (AED).

29) The business method according to claim 27, wherein the list of instructional topics include at least a utility of the medical device item, an operation of the medical device item, a device troubleshooting item and a device maintenance item.

30) The business method according to claim 27, further comprising:
a) providing an audio in at least one of the graphical user interfaces.

31) The business method according to claim 27, further comprising:
a) Providing linear and non-linear navigation from at least one graphical user interfaces to another of the graphical user interfaces.

32) The business method according to claim 27, wherein the instructional information in each of the plurality of instructional graphical user interface includes a text description of one or more operational steps pertaining to the selected item on the list of instructional sub-topics.

33) The business method according to claim 32, further comprising:
a) providing in each of the plurality instructional graphical user interfaces one or more still images illustrating the text description of the one or more operational steps.

34) The business method according to claim 32, further comprising:
a) providing in each of the plurality of instructional graphical user interfaces animation illustrating the text description of the one or more operational steps.

35) The business method according to claim 32, further comprising:
a) providing in at least one of the plurality of instructional graphical user interfaces a video illustrating the text description of the at least one instructional graphical user interfaces.

36) The business method according to claim 32, wherein each of the plurality of instructional graphical user interfaces is provided based on the order in which the one or more operational steps in the text description would be performed during proper operation of the device.

37) The business method according to claim 36, wherein the medical device is an Automatic External Defibrillator (AED).

38) A method for providing instructional information on the use of a medical device to a user computer, the method comprising:
a) providing a medical device control object, the medical device control object simulating a control of the medical device;
b) providing a medical device first aid instrument object, the medical device first aid object, simulating a first aid component of the medical device; and
c) providing feedback, the feedback indicating the correctness of an interaction with the medical device control object and the medical device first aid instrument object.

39) The method according to claim 38, wherein the medical device is an Automatic External Defibrillator (AED).

40)The method according to claim 38, further comprising:
a) providing an audio, the audio disclosing instructional information related to the medical device.

41) The business method according to claim 38, further comprising:
a) providing text description of one or more operational steps pertaining to the medical device.

42) The business method according to claim 41, further comprising:
a) providing one or more still images illustrating the concept disclosed by the text description of the one or more operational steps.

43) The business method according to claim 41, further comprising: providing a video illustrating the concept disclosed by the text description of the one or more operational steps.
